(19) United States
(12) Patent Application Publication
(10) Pub. No.: US 2002/0118754 A1
(43) Pub. Date: Aug. 29, 2002

(54) Device and method for selecting coding mode for video encoding system

(76) Inventor: Sung-Kyu Choi, Kwangmyong-Shi (KR)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/726,510

(22) Filed: Dec. 1, 2000

(30) Foreign Application Priority Data
Dec. 1, 1999 (KR) 1999-54329

(51) Int. Cl. H04N 7/12

(52) U.S. Cl. 375/240.14; 375/240.17

(57) ABSTRACT

A coding mode selecting method, in which an SAD between input frames is used in a video encoding system, includes the steps of: detecting the SAD value of input frame data; determining whether the detected SAD value exceeds a predetermined SAD threshold; coding the input frame in an intra-coding mode when the SAD value of the input frame exceeds the SAD threshold; and coding the input frame in an inter-coding mode when the SAD value of the input frame does not exceed the SAD threshold.

### PRIORITY

This application claims priority to an application entitled “Device and Method for Selecting Coding Mode for Video Encoding System” filed in the Korean Industrial Property Office on Dec. 1, 1999 and assigned Serial No. 99-54329, the contents of which are hereby incorporated by reference.

### BACKGROUND OF THE INVENTION

1. Field of the Invention

The present invention relates generally to image processing, and more particularly, to a coding device and method for a video encoding system capable of efficiently coding an image in a frame at a low bit rate.

2. Description of the Related Art

In general, there are two coding modes using a correlation between frames in a video encoding system: an intra-coding mode in which compaction of information is performed depending on the correlation in the frames irrespective of correlation between the frames; and an inter-coding mode in which another frame data most adjacent to the present data are searched and only a difference between the two data is coded.

FIG. 1 is a block diagram showing the structure of a conventional video encoding system using correlation between frames. Referring to FIG. 1, a discrete cosine transformer 104 transforms the frame data of an input image from a spatial domain to a frequency domain according to a discrete cosine transform (DCT) algorithm. A quantizer 106 quantizes DCT coefficients generated at the DCT part 104. A de-quantizer 108 dequantizes the quantized DCT coefficients into DCT coefficients. An inverse discrete cosine transformer (IDCT) 110 inversely discrete-cosine-transforms the DCT frame data into original one. A prediction memory 115 stores the previous frame data to use correlation between the frames. A motion prediction part 114 compares the present input frame data applied through a video input device with the previous frame data to output a block-based motion vector. The input frame data are coded in either of the intra-coding mode or the inter-coding mode. For block data of which the motion vector is output, only a data difference from the block existing in the previous frame is coded. A coding controller 102 determines the step size of quantization based on the quantity of data to be encoded.

FIG. 2 is a diagram showing an example of frame data coded by the video encoding system shown in FIG. 1. Referring to FIG. 2, the frame denoted by I is an intra-coded frame, the frame denoted by P is a frame coded by prediction with respect to the previous frame, the frame denoted by B is a frame coded by prediction with respect to the previous and next frames.

However, the coding mode of the conventional video encoding system as shown in FIG. 1 is predefined as illustrated in FIG. 2 in which the I, B and P frames are iteratively coded in the unit of frame, or the coding mode is determined according only to the quantity of output data, so that an image of almost no difference from the previous frame is coded as an I frame, which requires a high bit rate, or an image which is significantly different from the previous frame is coded as a P or B frame. Furthermore, such a conventional encoding method is inefficient in a case where the image having much difference from the previous frame contains important information.

### SUMMARY OF THE INVENTION

It is, therefore, an object of the present invention to provide a device and method for selecting a coding mode of a video encoding system that substantially codes important information with a reduced number of codes and facilitates search in coding an input image.

To achieve the above object, there is provided a coding mode selecting method, in which an SAD (sum of absolute pixel differences) between input frames is used in a video encoding system, including the steps of: detecting the SAD value of input frame data; determining whether the detected SAD value exceeds a predetermined SAD threshold; coding the input frame in an intra-coding mode when the SAD value of the input frame exceeds the SAD threshold; and coding the input frame in an inter-coding mode when the SAD value of the input frame does not exceed the SAD threshold.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram showing the structure of a conventional video encoding system;

FIG. 2 is a diagram showing an example of prediction coded frame data according to prior art;

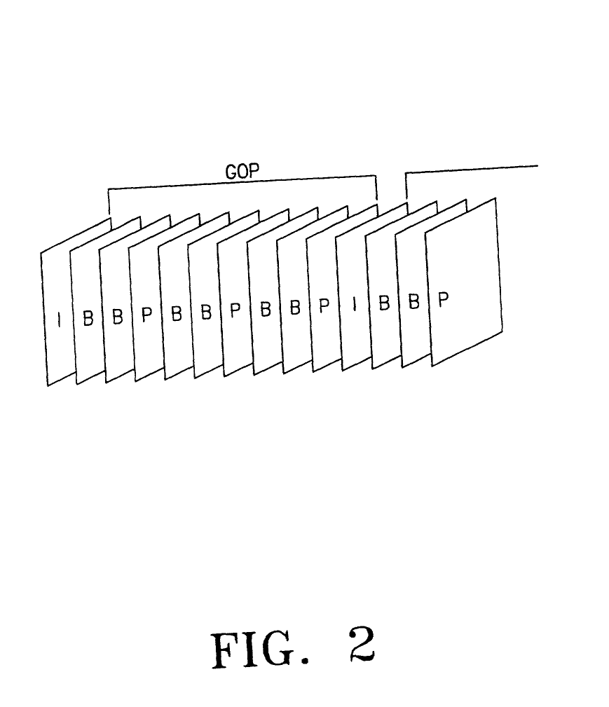

FIG. 3 is a block diagram showing the structure of a video encoding system in accordance with an embodiment of the present invention; and

FIG. 4 is a flowchart showing a procedure for selecting a coding mode using a SAD between frames in accordance with an embodiment of the present invention.

### DETAILED DESCRIPTION OF THE PREFERRED EMBODIMENT

A preferred embodiment of the present invention will be described below with reference to the accompanying drawings. In the following description, well-known functions or constructions are not described in detail since they would obscure the invention in unnecessary detail.

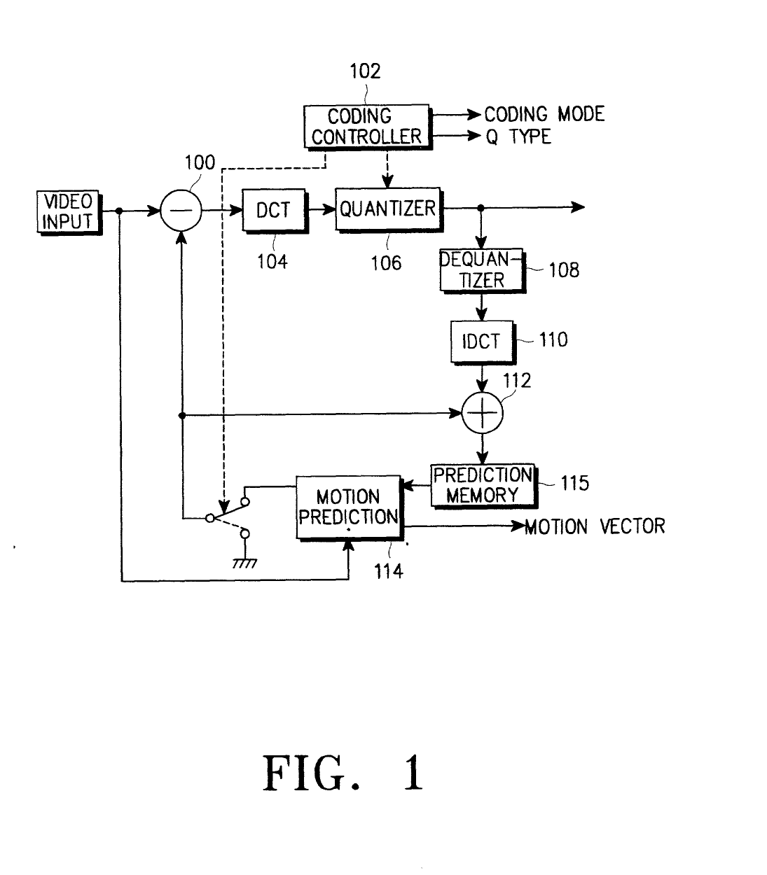

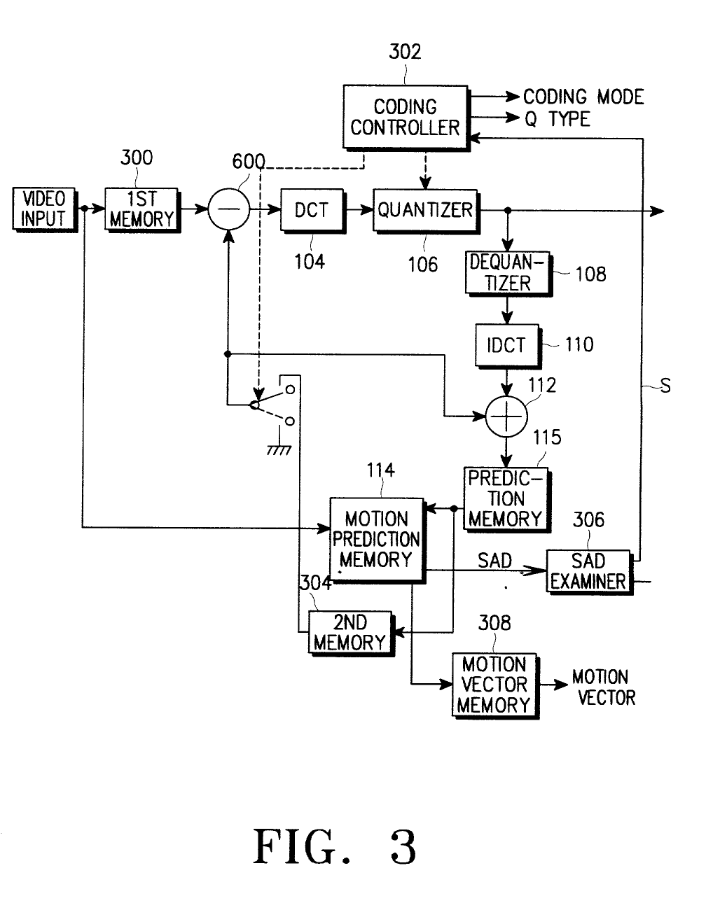

FIG. 3 is a block diagram showing the structure of a video encoding system in accordance with an embodiment of the present invention. Referring to FIG. 3, the encoding system of the present invention further includes a first memory 300, a second memory 304 and a SAD examiner 306 in addition to the conventional encoding system shown in FIG. 1.

A description will now be made as to operation of the video encoding system shown in FIG. 3.

Frame data of an input image from a video input device such as a camera are first input to the first memory 300 and a motion prediction part 114. The motion prediction part 114 compares the present frame data stored in the first memory with the previous frame data stored in a prediction memory 115 to detect block-based SAD values (difference component values), which are output to the SAD examiner 306. In the meantime, the previous frame data of the prediction memory 115 are stored in the second memory 304 and the presently coded frame data are recorded in the prediction memory 115. The SAD value is an absolute value of the difference between the pixel of the present frame and that of the previous frame, which value means a difference component value between the present frame and the previous frames accumulated by blocks. As described above, the block-based SAD values of the first frame interval generated from the motion prediction part 114 are sequentially applied to the SAD examiner 306, which compares the SAD value of the input frame data with a predetermined SAD threshold and applies coding selection information “S” to a coding controller 302. The coding controller 302 determines, based on the coding selection information “S”, whether to code the input frame in the intra-coding mode or in the inter-coding mode.

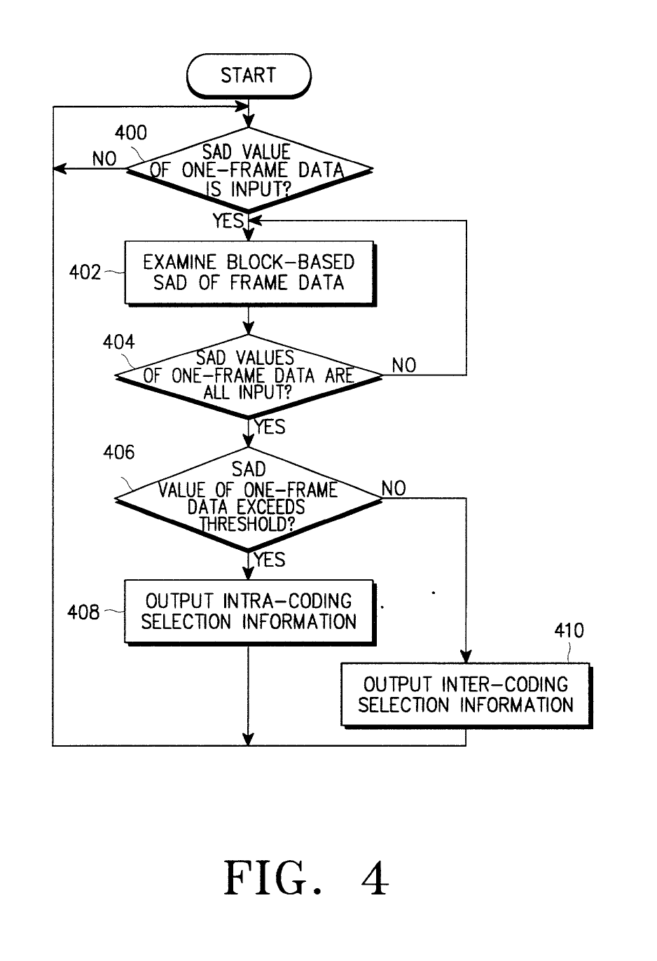

FIG. 4 is a flowchart showing the procedure of the SAD examiner 306 for determining the coding selection information based on the SAD value of the input frame data in accordance with the embodiment of the present invention. A detailed description will now be made as to the embodiment of the present invention with reference to FIGS. 3 and 4.

First, image data input in the unit of frame from a video input device such as a camera are stored in the first memory 300 and input to the motion prediction part 114. The motion prediction part 114 detects block-based SAD values for the one-frame data of the present input image and sequentially outputs the detected SAD values to the SAD examiner 306. Upon receiving the SAD values in step 400, the SAD examiner 306 proceeds to step 402 to sequentially examine the block-based SAD values of the one-frame data applied from the motion prediction part 114. Subsequently, the SAD examiner 306 determines in step 404 whether the block-based SAD values of the one-frame data are all received.

With all the block-based SAD values of the one-frame data received, the SAD examiner 306 determines in step 406 whether the individual SAD values of the one-frame data exceed the predetermined SAD threshold. The SAD threshold refers to a reference value of the SAD of input frame data to select a coding mode for coding the input frame data more efficiently.

If the SAD values of the input frame data exceed the SAD threshold in step 406, the SAD examiner 306 proceeds to step 408 to output to the coding controller 302 the coding selection information “S” for coding the input frame data in the intra-coding mode. Otherwise, if the SAD values of the input frame data do not exceed the SAD threshold in step 406, the SAD examiner 306 proceeds to step 410 to output to the coding controller 302 the coding selection information “S” for coding the input frame data in the inter-coding mode.

Accordingly, the coding controller 302 codes the input frame data in the coding mode selected at the SAD examiner 306 based on the coding selection information “S” applied from the SAD examiner 306, thereby more efficiently coding the frame data according to the SAD values.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A device for selecting a coding mode for a video encoding system, comprising:
a first memory for storing frame data of an input image;
a second memory for storing the previous frame data;
a motion prediction part for comparing the present input frame data stored in the first memory with the previous frame data stored in the second memory to detect a SAD (sum of absolute pixel differences) value; and
an SAD examiner for generating coding selection information for coding the frame data in an intra-coding mode when the SAD value of the input frame data output from the motion prediction part exceeds a predetermined SAD threshold, or in an inter-coding mode when the SAD value of the input frame data does not exceed the predetermined SAD threshold.

2. A coding mode selecting method in which an SAD value between input frames is used in a video encoding system, the coding mode selecting method comprising the steps of:
detecting the SAD value of input frame data;
determining whether the detected SAD value exceeds a predetermined SAD threshold;
coding the input frame in an intra-coding mode when the SAD value of the input frame exceeds the SAD threshold; and
coding the input frame in an inter-coding mode when the SAD value of the input frame does not exceed the SAD threshold.

3. A device for selecting a coding mode for a video encoding system, comprising:
a motion prediction part for comparing data of a present input frame with data of a previous frame to detect a SAD (sum of absolute pixel differences) value; and
an SAD examiner for generating coding selection information for coding the frame data in an intra-coding mode when the SAD value of the input frame data output from the motion prediction part exceeds a predetermined SAD threshold, or in an inter-coding mode when the SAD value of the input frame data does not exceed the predetermined SAD threshold.
